(19) United States
(12) Patent Application Publication
(10) Pub. No.: US 2023/0062124 A1
(43) Pub. Date: Mar. 2, 2023

(54) METHOD OF DETERMINING WHETHER A FRAUD CLAIM IS LEGITIMATE

(71) Applicant: Royal Bank of Canada, Toronto (CA)

(72) Inventors: Leah Sossin, Toronto (CA); Parth Solanki, Ajax (CA); Evans Mosomi, Courtice (CA); Sonia Yasmin, Stittsville (CA); Venkati Brahmam Chinnari, Milton (CA); Daniel Swerdfeger, Toronto (CA); Adam Cheng, Toronto (CA); Robin Zhang, Burlington (CA)

(21) Appl. No.: 17/891,816

(22) Filed: Aug. 19, 2022

Related U.S. Application Data
(60) Provisional application No. 63/237,810, filed on Aug. 27, 2021.

(51) Int. Cl. G06Q 30/00

(52) U.S. Cl. CPC G06Q 30/0185

(57) ABSTRACT

There is described a method of determining whether a fraud claim initiated by a client is legitimate. The method is performed by one or more processors. A fraud claim is received from the client. The fraud claim is in respect of a potentially fraudulent transaction associated with the client. Client data associated with the client is retrieved. The client data includes data relating to historical financial transactions associated with the client. Based on the data relating to the historical financial transactions associated with the client, and based on one or more parameters of the potentially fraudulent transaction, a fraud score associated with the fraud claim is determined. Based on the fraud score, a determination is made as to whether the fraud claim is legitimate.

### TECHNICAL FIELD

The present disclosure is directed at methods, systems, and techniques for determining whether a fraud claim is legitimate.

### BACKGROUND

Credit card fraud is a major problem in the financial services industry. Despite the prevalence of credit card fraud, there exist many instances of credit card fraud claims that are, themselves, fraudulent or otherwise illegitimate. For example, it is possible that the victim of alleged credit card fraud may misidentify a transaction as being fraudulent, and may report the transaction as such. More typically, bad-faith clients may seek to defraud a credit card company by deliberately claiming that a genuine transaction, initiated by the client, is fraudulent.

It can be difficult or at least time-consuming for credit card companies to efficiently and accurately determine whether credit card fraud claims, or fraud claims more generally, are legitimate (known as l′-party fraud) or illegitimate (known as 3^{rd}-party fraud). There is therefore a need in the art for improved methods of determining whether a fraud claim is legitimate.

### SUMMARY

According to a first aspect of the disclosure, there is provided a method of determining whether a fraud claim initiated by a client is legitimate, the method being performed by one or more processors and comprising: receiving the fraud claim from the client, wherein the fraud claim is in respect of a potentially fraudulent transaction associated with the client; retrieving client data associated with the client, wherein the client data comprises data relating to historical financial transactions associated with the client; determining, based on the data relating to the historical financial transactions associated with the client, and based on one or more parameters of the potentially fraudulent transaction, a fraud score associated with the fraud claim; and determining, based on the fraud score, whether the fraud claim is legitimate.

The one or more parameters may comprise one or more of: data indicating a type of merchant associated with the potentially fraudulent transaction; an amount associated with the potentially fraudulent transaction; a time of day associated with the potentially fraudulent transaction; and a day of a week associated with the potentially fraudulent transaction.

Determining the fraud score may comprise: inputting the client data to a trained machine learning model; and outputting the fraud score using the machine learning model.

The client data may further comprise data relating to one or more characteristics of the client; and determining the fraud score may be further based on the data relating to the one or more characteristics of the client.

The one or more characteristics may comprise one or more of: an age of the client; an earning potential of the client; a gender of the client; an address of the client; and a credit score of the client.

Determining the fraud score may comprise: extracting, based on the data relating to the historical financial transactions associated with the client, one or more client transaction features; comparing the one or more client transaction features to stored client transaction features; and based on the comparison, determining the fraud score.

The one or more client transaction features and the stored client transaction features may be representative of one or more of: types of merchants; for each type of merchant from among multiple types of merchants, amounts associated with the type of merchant; one or more spending patterns; times of day; and days of a week.

The method may further comprise, prior to receiving the fraud claim from the client, obtaining the stored client transaction features by: retrieving other client data associated with multiple other clients, wherein the other client data comprises data relating to historical financial transactions associated with the other clients; extracting, based on the data relating to the historical financial transactions associated with the other clients, other client transaction features; and storing the other client transaction features.

Retrieving the other client data may comprise: retrieving a dataset of client data; extracting features from the dataset of client data; based on one or more similarities between the extracted features, assigning each feature to one of multiple groups; and retrieving the other client data from one of the groups.

Extracting the other client transaction features may comprise: inputting the other client data to a trained machine learning model; and outputting the other client transaction features using the trained machine learning model.

The machine learning model may be an unsupervised machine learning model.

Determining the fraud score may further comprise: extracting, based on the data relating to the one or more characteristics of the client, one or more client characteristic features; comparing the one or more client characteristic features to stored other client characteristic features; and based on the comparison, determining the fraud score.

The method may further comprise, prior to receiving the fraud claim from the client, obtaining the stored other client characteristic features by: retrieving other client data associated with multiple other clients, wherein the other client data comprises data relating to characteristics associated with the other clients; extracting, based on the data relating to the characteristics associated with the other clients, other client characteristic features; and storing the other client characteristic features.

Retrieving other client data associated with multiple other clients may comprise: retrieving a dataset of client data; extracting features from the dataset of client data; based on one or more similarities between the extracted features, assigning each feature to one of multiple groups; and retrieving the other client data associated with the multiple other clients.

Extracting the other client characteristic features may comprise: inputting the other client data to a trained machine learning model; and outputting the other client characteristic features using the trained machine learning model.

The trained machine learning model may be an unsupervised machine learning model.

Determining the fraud score may comprise: extracting, based on the data relating to the historical financial transactions associated with the client, one or more client transaction features; comparing the one or more client transaction features to stored client transaction features; extracting, based on the data relating to the one or more characteristics of the client, one or more client characteristic features; comparing the one or more client characteristic features to stored other client characteristic features; and based on the comparisons, determining the fraud score.

Determining the fraud score may further comprise: inputting the one or more client transaction features and the one or more client characteristic features to a trained machine learning model; and outputting the fraud score using the trained machine learning model.

Determining whether the fraud claim is legitimate may comprise: comparing the fraud score to a threshold; and based on the comparison, determining whether the fraud claim is legitimate.

Determining whether the fraud claim is legitimate may comprise determining that the fraud claim is legitimate; and the method may further comprise, in response to determining that the fraud claim is legitimate, initiating an instruction so as to reverse the potentially fraudulent transaction.

The method may further comprise, prior to determining whether the fraud claim is legitimate: determining a trust score associated with the client; and adjusting the fraud score based on the trust score, wherein determining whether the fraud claim is legitimate is further based on the adjusted fraud score.

According to a further aspect of the disclosure, there is provided a system for determining whether a fraud claim initiated by a client is legitimate, the system comprising: one or more databases storing client data, wherein the client data comprises data relating to historical financial transactions associated with the client; and one or more processors configured to: receive the fraud claim from the client, wherein the fraud claim is in respect of a potentially fraudulent transaction associated with the client; retrieve the client data from the one or more databases; determine, based on the data relating to the historical financial transactions associated with the client, and based on one or more parameters of the potentially fraudulent transaction, a fraud score associated with the fraud claim; and determine, based on the fraud score, whether the fraud claim is legitimate.

According to a further aspect of the disclosure, there is provided a computer-readable medium having stored thereon computer program code configured when executed by one or more processors to cause the one or more processors to perform a method comprising: receiving the fraud claim from the client, wherein the fraud claim is in respect of a potentially fraudulent transaction associated with the client; retrieving client data associated with the client, wherein the client data comprises data relating to historical financial transactions associated with the client; determining, based on the data relating to the historical financial transactions associated with the client, and based on one or more parameters of the potentially fraudulent transaction, a fraud score associated with the fraud claim; and determining, based on the fraud score, whether the fraud claim is legitimate.

This summary does not necessarily describe the entire scope of all aspects. Other aspects, features and advantages will be apparent to those of ordinary skill in the art upon review of the following description of specific embodiments.

### BRIEF DESCRIPTION OF THE DRAWINGS

In the accompanying drawings, which illustrate one or more example embodiments:

FIG. 1 depicts a computer network that comprises an example embodiment of a system for determining whether a fraud claim is legitimate.

FIG. 2 is a block diagram of a server comprised in the system depicted in FIG. 1, according to an example embodiment of the disclosure.

FIG. 3 is a schematic diagram of various software and hardware components in the system depicted in FIG. 1, according to an example embodiment of the disclosure.

FIG. 4 is a flow diagram of a method of initiating and processing a fraud claim, according to an example embodiment of the disclosure.

FIG. 5 is a flow diagram of a method of determining whether a fraud claim is legitimate, according to an example embodiment of the disclosure.

FIGS. 6A and 6B are a flow diagram of a method of determining whether a fraud claim is legitimate, according to another example embodiment of the disclosure.

### DETAILED DESCRIPTION

Herein, there are described methods, systems, and techniques for determining whether a fraud claim initiated by a client is legitimate. A legitimate fraud claim may be referred to as a case of “third-party fraud”, e.g. a third party has obtained the client's card/card number and is responsible for the fraudulent transaction. A fraud claim that is not legitimate may be referred to as a case of “first-party fraud”, e.g. it is the client themselves who are defrauding the bank.

The fraud claim is first received from the client. The fraud claim is in respect of a potentially fraudulent transaction associated with the client. In response to receiving the fraud claim, client data associated with the client is retrieved. The client data comprises data relating to historical financial transactions associated with the client. The client data may also comprise additional data. For example, the client data may further comprise data relating to one or more characteristics of the client, such as an age of the client, an earning potential or a salary of the client, and an address of the client.

Based on the data relating to the historical financial transactions associated with the client, and based on one or more parameters of the potentially fraudulent transaction, a fraud score associated with the fraud claim is determined. The one or more parameters of the potentially fraudulent transaction may include, for example, data indicating a type of merchant associated with the potentially fraudulent transaction. Determining the fraud score may be further based on the data relating to the one or more characteristics of the client. In particular, one or more processors may process the data (for example, using one or more machine learning models) to determine the fraud score.

Based on the fraud score, the one or more processors may determine whether the fraud claim is legitimate. For example, the fraud score may be used to infer a likelihood that the potentially fraudulent transaction is in fact fraudulent. For instance, the fraud score may be compared to a threshold, and if the fraud score is greater than the threshold then the fraud claim may be determined to be legitimate.

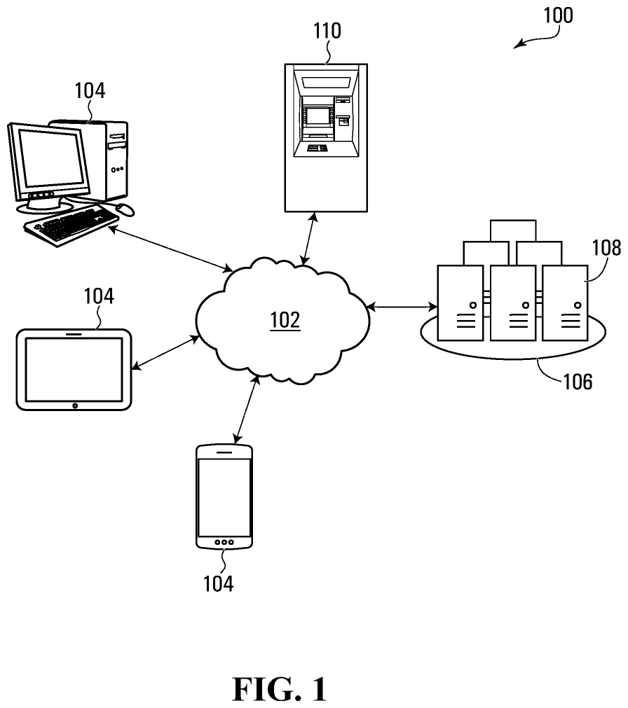

Referring now to FIG. 1, there is shown a computer network 100 that comprises an example embodiment of a system for determining whether a fraud claim initiated by a client is legitimate. More particularly, computer network 100 comprises a wide area network 102 such as the Internet to which various user devices 104, an ATM 110, and a data center 106 are communicatively coupled. Data center 106 comprises a number of servers 108 networked together to collectively perform various computing functions. For example, in the context of a financial institution such as a bank, data center 106 may host online banking services that permit users to log in to servers 108 using user accounts that give them access to various computer-implemented banking services, such as online fund transfers. Furthermore, individuals may appear in person at ATM 110 to withdraw money from bank accounts controlled by data center 106.

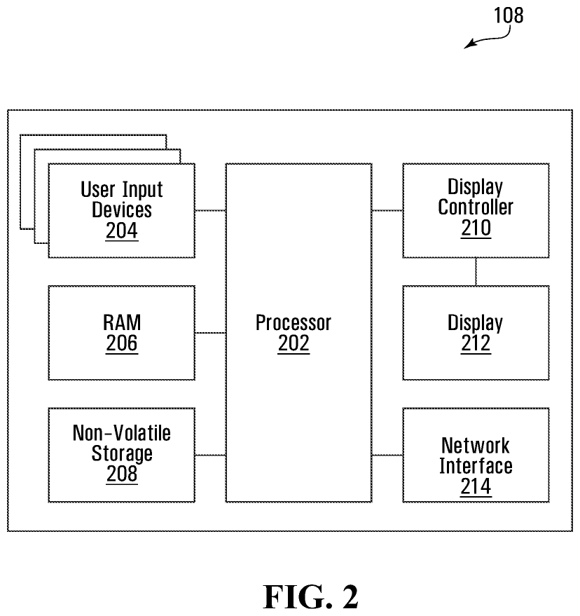

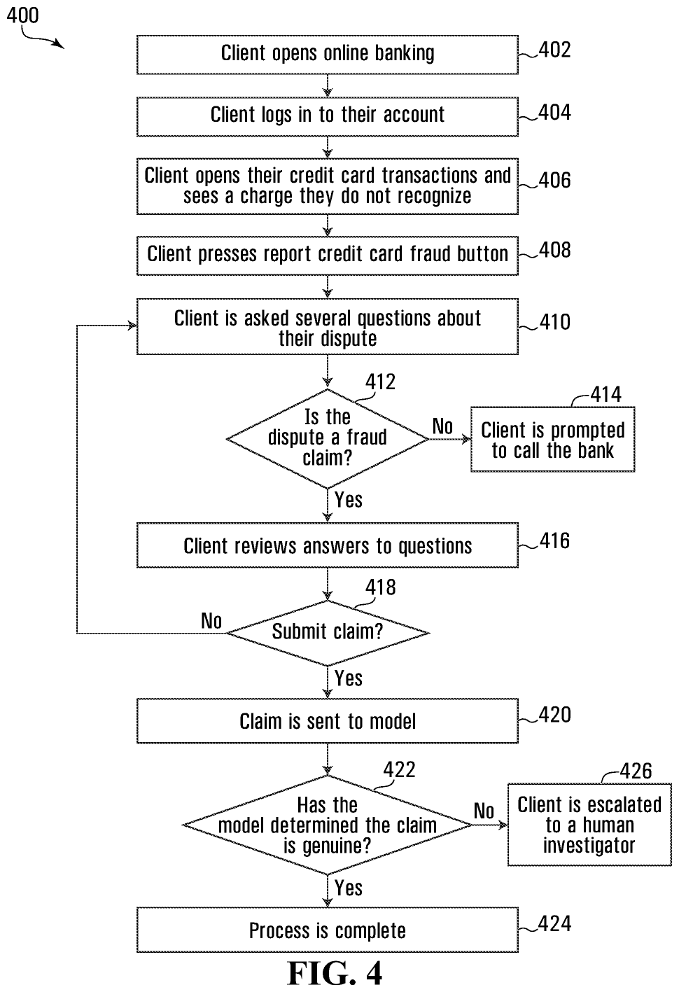

Referring now to FIG. 2, there is depicted an example embodiment of one of the servers 108 that is comprised in data center 106. The server 108 comprises a processor 202 that controls the server 108's overall operation. Processor 202 is communicatively coupled to and controls several subsystems. These subsystems comprise user input devices 204, which may comprise, for example, any one or more of a keyboard, mouse, touch screen, voice control; random access memory (“RAM”) 206, which stores computer program code for execution at runtime by the processor 202; non-volatile storage 208, which stores the computer program code executed by the RAM 206 at runtime; a display controller 210, which is communicatively coupled to and controls a display 212; and a network interface 214, which facilitates network communications with wide area network 104 and the other servers 108 in the data center 106. Non-volatile storage 208 has stored on it computer program code that is loaded into RAM 206 at runtime and that is executable by processor 202. When the computer program code is executed by processor 202, processor 202 causes the server 108 to implement a method for determining whether a fraud claim is legitimate, such as is described in more detail in connection with FIGS. 4-6 below. Additionally or alternatively, servers 108 may collectively perform the method for determining whether a fraud claim is legitimate using distributed computing. While the system depicted in FIG. 2 is described specifically in connection with one of the servers 108, analogous versions of the system may also be used for user devices 104.

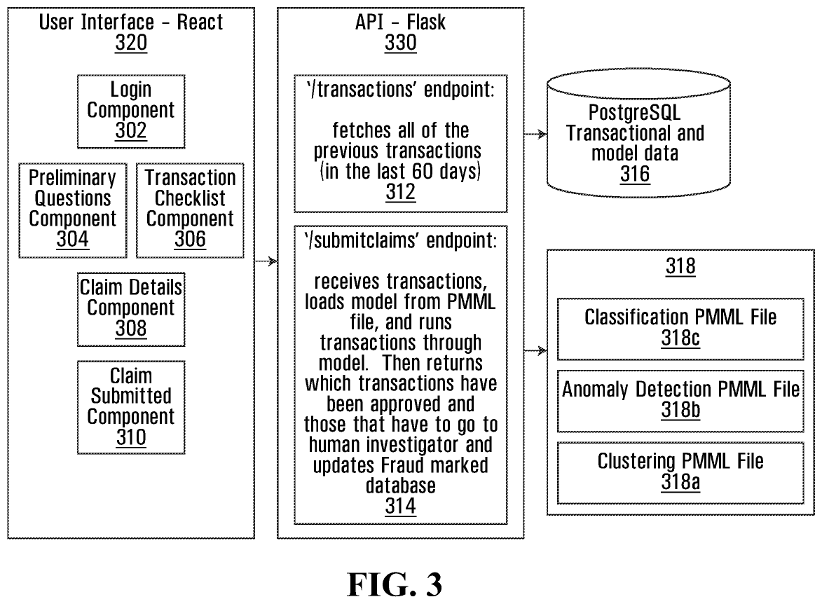

Turning to FIG. 3, there is now schematically shown an embodiment of various software and hardware components of the server 108 shown in FIG. 2. In particular, the server 108 includes a number of user interface components 320 and application programming interface (API) components 330.

User interface components 320 include software and hardware components for detecting and processing various data input to a user device 104 being operated by a client. In particular, user interface components 320 include a login component 302 for detecting the input of login credentials provided to the user device 104 by the client, and validating the login credentials. User interface components 320 further include a preliminary questions component 304 for, in response to detecting receipt of a fraud claim, displaying questions to the client on the user device 104, and receiving and processing answers thereto.

User interface components 320 further include a transactions checklist component 306, a claim details component 308, and a claim submitted component 310. Transaction checklist component 306 displays a list of a past number of transactions (such as transactions that have been posted in the past 60 days) and an option to select suspicious transactions. Claim details component 308 enables the client to answer questions that were previously asked of the client, for example by a call center responding to a dispute initiated by the client in respect of one or more transactions. Claim details component 308 also includes a survey component embedded therein to allow questions to be dynamically displayed depending on the client's previous answers. Claim submitted component 310 displays the result of a processed fraud claim; for example, whether the fraud claim is approved, unsuccessful, to be disputed with the merchant, or under escalation.

User interface components 320 are configured to communicate with API components 330 for fetching various data relating to clients of the financial institution. For example, API components 330 include a transactions endpoint component 312. Transactions endpoint component 312 enables one or more of servers 108 to communicate with a database 316 for retrieving financial and other data relating to clients of the financial institution. Such data may include a detailed history of financial transactions initiated by clients of the financial institution, as well as personal details (e.g. age, address, gender, etc.) of the clients.

API components 330 further include a submit claims endpoint component 314. Submit claims endpoint component 314 enables one or more of servers 108 to access components of one or more machine learning models 318 that may be stored on one or more databases. Components of the one or more machine learning models 318 include a clustering component 318a, an anomaly detection component 318b, and a classification component 318c. As described in further detail below, clustering component 318a, anomaly detection component 318b, and classification component 318c are accessed by submit claims endpoint component 314 during the processing of fraud claims so as to determine a likelihood of a legitimacy of the fraud claim.

Turning to FIG. 4, there is now shown a flow diagram of an example method of processing a fraud claim initiated by a client. The fraud claim may be initiated by a client of the system shown in FIG. 1, using for example one of user devices 104.

Starting at block 402, the client accesses their online banking account. For example, the client may interact with their user device 104 to access their online banking account using an application stored on their user device 104. The application may open a communications channel between the user device 104 and data center 106.

At block 404, the client logs into their user account. For example, in response to being prompted to enter one or more user credentials, the client enters one or more user credentials into their user device 104. The user credentials are then verified by data center 106, and upon verification the client is granted access to their online account.

At block 406, the client may access their credit or debit card transaction history stored within their account. The card transaction history includes data (such as amounts, merchants, dates, and times) relating to historical transactions that have occurred using one or more of the client's cards associated with the financial institution. Upon reviewing their card transaction history, the client may identify one or more transactions that they do not recognize and that may be fraudulent.

At block 408, the client initiates a dispute, for example by activating one or more icons displayed on user device 104 and that are activatable in order to report suspected card fraud or to otherwise query a transaction.

At block 410, the client is asked one or more questions regarding the possible fraud claim. For example, in response to receiving the possible fraud claim, data center 106 may cause to be displayed on the user device 104 one or more questions relating to the transaction under dispute. For example, the questions may include: “Do you recognize this transaction?”

At block 412, the data center 106 determines whether the dispute initiated by the client relates in fact to a fraud claim. For example, if in response to the question “Do you recognize this transaction?” the client enters the answer “Yes”, then the data center 106 may determine that the client is not disputing the legitimacy of the transaction. Therefore, at block 414, the data center 106 may determine that there is no need to analyze the legitimacy of the transaction under question, and instead the client may simply be prompted to contact a representative of the card company for further discussion.

Alternatively, if in response to the question “Do you recognize this transaction?” the client enters the answer “No”, then the data center 106 may determine that the client is disputing the legitimacy of the transaction and is thereby initiating a actual fraud claim. Therefore, at block 416, the client is prompted to review the answers to the questions that were asked of the client at block 410.

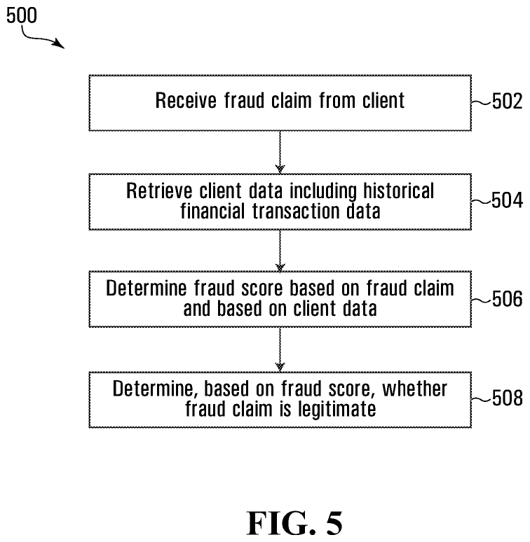

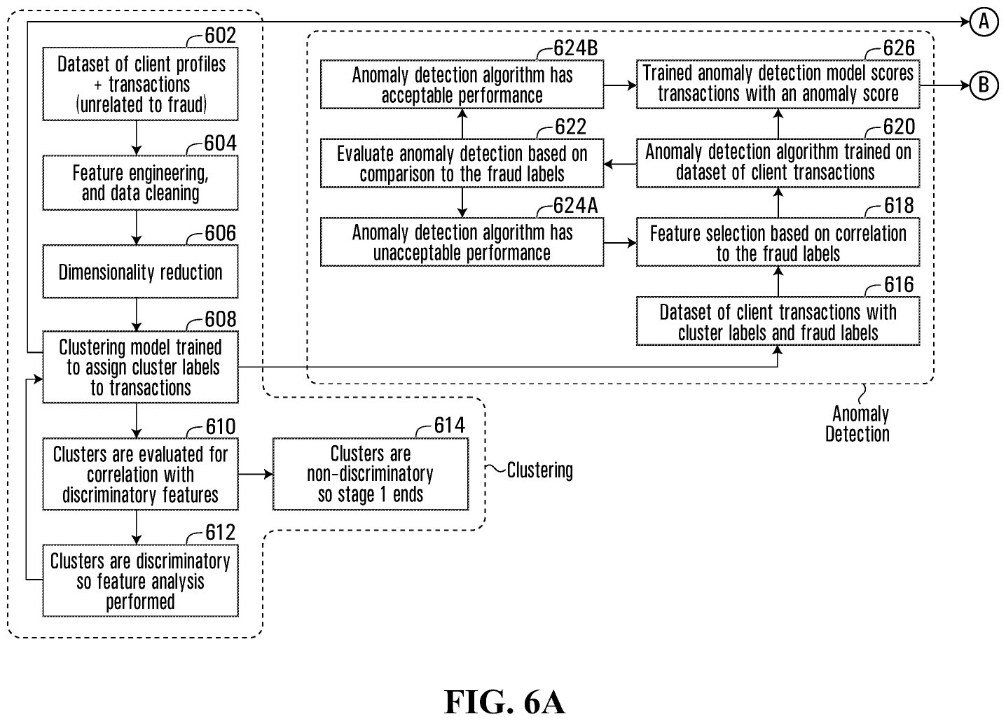

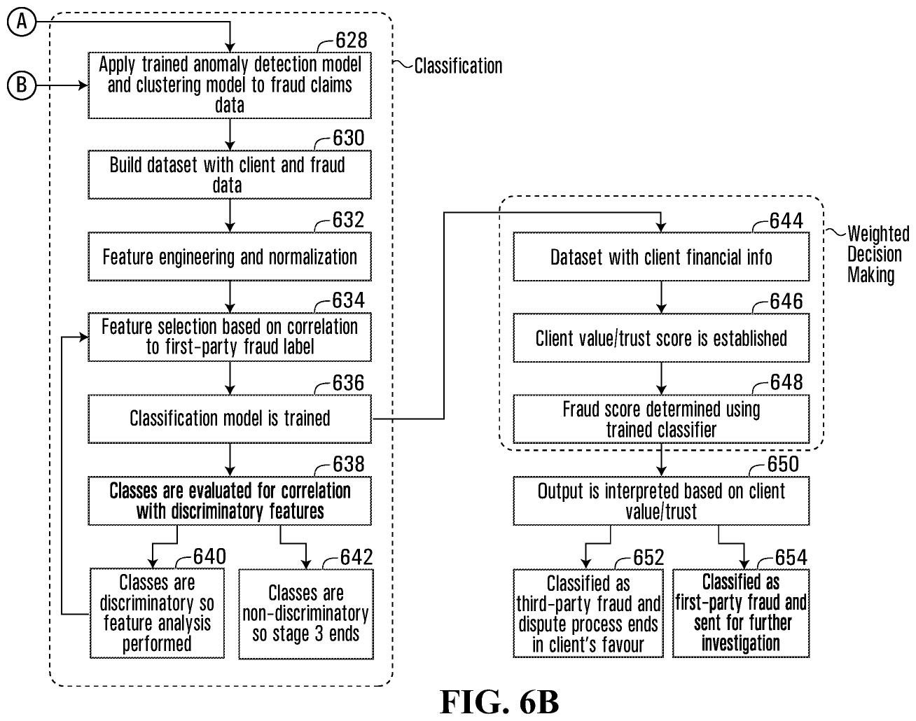

At block 418, after having reviewed the answers to the questions that were asked of the client at block 410, the client is prompted to submit the fraud claim for further review. If the client is satisfied with the answers to the questions that were asked of the client at block 410 and decides to submit the fraud claim, then the process proceeds to block 420 whereupon the fraud claim is processed for further review, as described in further detail below in connection with FIGS. 5 and 6. Alternatively, if the client is not satisfied with the answers to the questions that were asked at block 410 (for example, if the client notices an error in one or more answers that were provided by the client), then the process returns to block 410 whereat the client may edit one or more answers that were provided or alternatively may close the dispute entirely.

At block 420, the fraud claim is processed by a trained machine learning model (for example, machine learning model 318 comprising clustering component 318a, anomaly detection component 318b, and classification component 318c) in order to determine the legitimacy of the fraud claim. An example of processing a fraud claim is described in further detail below, first in a general manner (FIG. 5), and subsequently in an exemplary specific manner (FIGS. 6A and 6B).

At block 422, data center 106 determines whether the trained machine learning model has determined that the fraud claim is legitimate. If the trained machine learning model has determined that the fraud claim is legitimate, then at block 424 the process ends and data center 106 may take remedial action. For example, data center 106 may initiate an instruction to cause the disputed transaction to be reversed.

Alternatively, if the trained machine learning model has determined that the fraud claim is not legitimate, then at block 426 the fraud claim may be escalated to a human investigator for manual review.

Turning to FIG. 5, there is shown a flow diagram of an example method of determining whether a fraud claim initiated by a client (such as the fraud claim initiated by the client in FIG. 4) is legitimate. The determination of the legitimacy of the fraud claim may be carried out by a one or more computer processors using computer-readable code. For example, the determination may be performed by one or more servers 108 of data center 106 receiving the fraud claim from one or more of user devices 104.

At block 502, the fraud claim is received from the client. For example, a client of the financial institution identifies a historical financial transaction associated with themselves as being fraudulent, and requests that the transaction be reversed by the financial institution. The client therefore initiates a fraud claim in respect of the potentially fraudulent transaction, using their user device 104.

At block 504, client data including historical financial transaction data is retrieved by data center 106. For example, data center 106 may retrieve all, or a portion, of a record of the client's historical financial transactions. In addition, data center 106 may retrieve other client data, including data relating to personal details or characteristics of client, such data also being stored in, or otherwise accessible by, data center 106.

Based on the client data, and based on the one or more parameters of the potentially fraudulent transaction, data center 106 determines a fraud score for the fraud claim. For example, data center 106 may analyze, using a trained machine learning model, the historical financial transaction data, as well as the data relating to characteristics of the client, to determine the fraud score for the fraud claim. The machine learning model may be trained on data relating to historical financial transactions stored in respect of many other clients of the financial institution.

At block 508, data center 106 determines, based on the fraud score, whether the potentially fraudulent transaction is in fact fraudulent. For example, the fraud score may be compared to a threshold and, based on the outcome of the comparison, data center 106 may determine whether the potentially fraudulent transaction is in fact fraudulent. The threshold and/or the fraud score may be adjusted based on a number of parameters, such as a trust score associated with the client. For example, if this is the client's first disputed transaction over a long period of time, then data center 106 may determine that the fraud claim is more likely to be genuine, and the fraud score and/or the threshold may be correspondingly adjusted.

Turning to FIGS. 6A and 6B, there is now described in more detail, and with additional reference to FIG. 3, an example method of training a machine learning model for determining whether a fraud claim is legitimate, as well as deploying the trained machine learning model to determine whether the fraud claim is legitimate. In the context of FIGS. 6A and 6B, the trained machine learning model includes a trained clustering component 318a, a trained anomaly detection component 318b, and a trained classification component 318c. The training of the machine learning model, based on trained clustering component 318a, trained anomaly detection component 318b, and trained classification component 318c, is shown at blocks 602-642. The deployment of the trained machine learning model, to determine the legitimacy of a fraud claim, is shown at blocks 644-654.

At blocks 602-614, a dataset of historical transactions (including both fraudulent and non-fraudulent transactions) is used to train clustering model 318a to cluster transactions. In particular, at block 602, a dataset of client profiles and transactions is retrieved from database 316 by transactions endpoint 312. The dataset includes data relating to profiles of various clients of the financial institution, including for example their age, addresses, genders, etc. The data further includes data relating to historical financial transactions associated with the clients. Such data includes, for example, an amount for each transaction, the merchant with whom the transaction was executed, and a date and time associated with the transaction.

At block 604, one or more signatures or features within the client data retrieved at block 602 are extracted from the client data, using clustering component 318a. According to some embodiments, clustering component 318a may comprise an agglomerative clustering algorithm configured to split clients into one of two groups (k=2), or a k-means algorithm. The features may be representative of any of various characteristics of the clients and their financial transactions. For example, the features may be representative of a client's likelihood to make online vs. offline purchases, the most common categories of merchants with whom the client transacts, typical locations at which the client transacts, typical times of day at which the client transacts, typical days of the week on which the client transacts, and a credit score of the client.

At block 606, depending on the number of dimensions of the features extracted from the client data by clustering component 318a, a dimensionality of the features may be reduced to ease further processing of the data. For example, principal component analysis may be used in order to reduce the dimensionality of the extracted features.

At block 608, clustering component 318a is trained on the extracted features to cluster clients within the client profile data into one or more groups, according to their associated features. For example, clients associated with features indicating typically frugal spending, or spending being generally confined to certain days of the week, may be clustered into a common group.

At block 610, the features in each group or cluster of clients are evaluated to determine whether the group has been created based on one or more discriminatory features. A discriminatory feature may be a feature that is representative of, or is associated with, a specific race, ethnicity, gender identify, sexual orientation, religion, socioeconomic status, or other sensitive category. For example, if a group consisting of only elderly female clients has been generated, the group may be identified as having been created based on discriminatory features, in this case age and gender.

At block 612, clusters identified as having been created based on one or more discriminatory features are further processed by clustering component 318a so as to redistribute clients clustered within that group among the other groups that have been created, based on one or more different features. For example, if a group consisting of only elderly female clients has been created, then clients within that group may be redistributed among the other groups, based on other features pertaining to those clients within the group, and the process then returns to block 608.

At block 614, if a cluster is identified as not having been created based on one or more discriminatory features, then the process ends.

After clustering of the clients has been performed by clustering component 318a, further processing of the client data is now performed by anomaly detection component 318b. In particular, at blocks 616-626, the same historical data that was used in the training of clustering component 318a, together with the cluster labels determined at block 608, is used to train an unsupervised anomaly detection model. Then, for every cluster created at block 608, anomaly detection component 318b will be configured to distinguish anomalous transactions (e.g. transactions that are atypical given a client's typical spending habits or other characteristics) from non-anomalous transactions (e.g. transactions that are typical of the client).

In particular, at block 616, a dataset of transactions associated with each client within a given cluster of clients is retrieved, using the output of block 608. Each transaction is associated with a fraud label which indicates whether the transaction is a standard transaction (i.e. was not disputed by the client) or an outlier transaction (i.e. was disputed by the client).

At block 618, optimal features within each cluster are identified. Optimal features are used to determine if a given transaction is an outlier. Such features can be identified in a partially automated way, wherein features are selected based on their correlation to the fraud label associated with the transaction. All transactions within the dataset that are not identified as being fraudulent (i.e. that have not been subject to a fraud claim, whether the fraud claim is ultimately deemed first-party fraud or third-party fraud) are labelled as genuine, non-fraudulent transactions.

At block 620, using one or more unsupervised machine learning techniques, anomaly detection component 318b outputs an anomaly score for each transaction. The anomaly score may be representative of whether or not a given transaction, identified as fraudulent by a client, is in fact anomalous. According to some embodiments, the one or more unsupervised machine learning techniques may include an autoencoder neural network (which may attempt to reconstruct the data output from clustering component 318a based on a compressed representation learned from previous training on non-anomalous transactions), or a one-class support vector machine (SVM) which is configured to represent standard data using complex boundaries and then determine whether new data (in this case, transactions) belong to the standard class.

At block 622, based on the output of blocks 620, anomaly detection component 318b's performance is evaluated in comparison to the fraud label assigned to each transaction. The algorithm is optimized such that there exists a strong correlation between the outputted anomaly score and the fraud label for a given transaction. For example, for transactions that are labelled as fraudulent (i.e. third-party fraudulent), anomaly detection component 318b should output a relatively high anomaly score. Similarly, for transactions that are labelled as legitimate (i.e. first-party fraudulent), anomaly detection component 318b should output a relatively low anomaly score.

At block 624A, if the performance of anomaly detection component 318b is considered unacceptable (e.g. lower than a preset threshold), then the process returns to block 618 whereat new feature selection is performed.

At block 624B, if the performance of anomaly detection component 318b is considered acceptable (e.g. equal to or higher than a preset threshold), then the process proceeds to block 626.

After this optimization, at block 626, anomaly detection component 318b is trained and labels each transaction in the dataset as either anomalous (e.g. fraudulent) or non-anomalous (e.g. genuine).

At blocks 628-642, classification component 318c is trained to identify whether or not a transaction claimed to be fraudulent by a client is legitimate (i.e. third-party fraud) or not legitimate (i.e. first-party fraud). In particular, classification component 318c is trained based on the outputs of block 608 and block 626, and based on a dataset of transactions subject to fraud claims.

At block 628, the models trained at blocks 608 (clustering model 318a) and 626 (anomaly detection model 318b) are applied to fraud claims transaction data from database 316. This will provide a dataset with each fraud claim therein having an associated cluster label and anomaly score. This dataset is then used to train classification model 318c as described in further detail below.

At block 630, the fraud claim dataset is assembled. The dataset includes data relating to the transactions claimed to be fraudulent, such as the time of day, the merchant, the merchant type, and the transaction amount. The dataset also contains historical transactional data for the client, such has how often the client transacts at particular merchant types, and/or at certain times of day, and/or via various channels (Card Not Present vs. Card Present). As noted above, the dataset also includes the cluster labels and anomaly scores generated through application of clustering model 318a and anomaly detection model 318b.

At block 632, using a trained machine learning model (such as an extra random trees algorithm), multiple signatures or features within the dataset retrieved at block 630 are extracted by classification component 318c. The features may be representative of any of various characteristics of the client that initiated the fraud claim, as well as any of various characteristics of the transaction under dispute.

At block 634, classification component 318c selects one or more features to be used for determining the legitimacy of the disputed transaction. The feature selection may be automatically performed by isolating a number of features (such as 30 features) that are most highly correlated to the fraud label associated with the transaction (i.e. whether or not the fraud claim relates to first-party fraud or third-party fraud).

At block 636, classification component 318c identifies the optimal parameters for the model, including specific weightings for each feature, by fitting the model to a subset of the data relating to historical fraud claims with associated fraud labels. The performance is then evaluated on a separate subset of the data. This process (known as K-fold cross validation) is repeated several times to maximize the generalizability of the model. For example, the dataset is split into k folds (randomly selected subsets of the dataset that are approximately the same size). For each one of the folds (the test set), the other k−1 folds are used as the training set. The output may provide an estimate of the performance of the model. The process may be repeated until an acceptable performance by the model is achieved.

A block 638, classification component 318c evaluates the relationship between the output of block 636 and discriminatory features such as gender and socioeconomic status. As described above in connection with clustering component 318a, this is done to ensure that sensitive characteristics are not swaying the output of the algorithm. Should such features be highly correlated with the model output, then at block 640 the algorithm is retrained to minimize discriminatory outputs, and the process then returns to block 634. If no discriminatory tendencies are observed, then at block 642 the training is considered complete.

After training of the machine learning model is complete (after block 636), the trained classification component 318c may be used to determine the legitimacy of a fraud claim, as now described in connection with blocks 644-654.

In particular, at block 644, a dataset comprising data relating to financial information of the client may be retrieved from database 316. For example, the data may relate to historical financial transactions associated with the client. The data may additionally comprise data relating to one or more personal characteristics of the client, such as an age of the client, an earning potential of the client, a gender of the client, an address of the client, and a credit score of the client

At block 646, a trust score may be determined based on the client's financial or other personal information. For instance, a long-standing or high-value client of the financial institution may be assigned a relatively high trust score.

At block 648, the dataset relating to the client is input to the trained classification component 318c obtained at block 636. One or more parameters of the transaction under dispute are also input to the trained classification component 318c. Such parameters may include, for example, data indicating a type of merchant associated with the potentially fraudulent transaction, an amount associated with the potentially fraudulent transaction, a time of day associated with the potentially fraudulent transaction, and a day of a week associated with the potentially fraudulent transaction.

At block 648, based on the data input to the trained classification component 318c, the trained classification component 318c outputs a fraud score or other parameter associated with the transaction under dispute. The fraud score or other parameter is indicative of a likelihood that the fraud claim relates to third-party fraud or first-party fraud.

At block 650, based on the client's trust score, the fraud score determined for the fraud claim may be correspondingly adjusted. For example, the likelihood that the fraud claim relates to third-party fraud may be artificially increased for a client assigned a relatively high trust score, and vice versa.

The fraud score (whether adjusted or not by the trust score) may be compared to a threshold, and, based on the comparison, classification component 318c may determine whether the fraud claim relates to third-party fraud (block 652) or first-party fraud (block 654). In the event that the fraud claim is determined to relate to third-party fraud, classification component 318c may issue an instruction to cause the associated transaction to be reversed. In the event that the fraud claim is determined to relate to first-party fraud, classification component 318c may cause a notification to be output to a human operator for further investigation.

Any of the processors used in the foregoing embodiments may comprise, for example, a processing unit (such as a processor, microprocessor, or programmable logic controller) or a microcontroller (which comprises both a processing unit and a non-transitory computer readable medium). Examples of computer-readable media that are non-transitory include disc-based media such as CD-ROMs and DVDs, magnetic media such as hard drives and other forms of magnetic disk storage, semiconductor based media such as flash media, random access memory (including DRAM and SRAM), and read only memory. As an alternative to an implementation that relies on processor-executed computer program code, a hardware-based implementation may be used. For example, an application-specific integrated circuit (ASIC), field programmable gate array (FPGA), system-on-a-chip (SoC), or other suitable type of hardware implementation may be used as an alternative to or to supplement an implementation that relies primarily on a processor executing computer program code stored on a computer medium.

The embodiments have been described above with reference to flow, sequence, and block diagrams of methods, apparatuses, systems, and computer program products. In this regard, the depicted flow, sequence, and block diagrams illustrate the architecture, functionality, and operation of implementations of various embodiments. For instance, each block of the flow and block diagrams and operation in the sequence diagrams may represent a module, segment, or portion of code, which comprises one or more executable instructions for implementing the specified action(s). In some alternative embodiments, the action(s) noted in that block or operation may occur out of the order noted in those figures. For example, two blocks or operations shown in succession may, in some embodiments, be executed substantially concurrently, or the blocks or operations may sometimes be executed in the reverse order, depending upon the functionality involved. Some specific examples of the foregoing have been noted above but those noted examples are not necessarily the only examples. Each block of the flow and block diagrams and operation of the sequence diagrams, and combinations of those blocks and operations, may be implemented by special purpose hardware-based systems that perform the specified functions or acts, or combinations of special purpose hardware and computer instructions.

The terminology used herein is for the purpose of describing particular embodiments only and is not intended to be limiting. Accordingly, as used herein, the singular forms “a”, “an”, and “the” are intended to include the plural forms as well, unless the context clearly indicates otherwise (e.g., a reference in the claims to “a challenge” or “the challenge” does not exclude embodiments in which multiple challenges are used). It will be further understood that the terms “comprises” and “comprising”, when used in this specification, specify the presence of one or more stated features, integers, steps, operations, elements, and components, but do not preclude the presence or addition of one or more other features, integers, steps, operations, elements, components, and groups. Directional terms such as “top”, “bottom”, “upwards”, “downwards”, “vertically”, and “laterally” are used in the following description for the purpose of providing relative reference only, and are not intended to suggest any limitations on how any article is to be positioned during use, or to be mounted in an assembly or relative to an environment. Additionally, the term “connect” and variants of it such as “connected”, “connects”, and “connecting” as used in this description are intended to include indirect and direct connections unless otherwise indicated. For example, if a first device is connected to a second device, that coupling may be through a direct connection or through an indirect connection via other devices and connections. Similarly, if the first device is communicatively connected to the second device, communication may be through a direct connection or through an indirect connection via other devices and connections. The term “and/or” as used herein in conjunction with a list means any one or more items from that list. For example, “A, B, and/or C” means “any one or more of A, B, and C”.

It is contemplated that any part of any aspect or embodiment discussed in this specification can be implemented or combined with any part of any other aspect or embodiment discussed in this specification.

The scope of the claims should not be limited by the embodiments set forth in the above examples, but should be given the broadest interpretation consistent with the description as a whole.

It should be recognized that features and aspects of the various examples provided above can be combined into further examples that also fall within the scope of the present disclosure. In addition, the figures are not to scale and may have size and shape exaggerated for illustrative purposes.

1. A method of determining whether a fraud claim initiated by a client is legitimate, the method being performed by one or more processors and comprising:
receiving the fraud claim from the client, wherein the fraud claim is in respect of a potentially fraudulent transaction associated with the client;
retrieving client data associated with the client, wherein the client data comprises data relating to historical financial transactions associated with the client;
determining, based on the data relating to the historical financial transactions associated with the client, and based on one or more parameters of the potentially fraudulent transaction, a fraud score associated with the fraud claim; and
determining, based on the fraud score, whether the fraud claim is legitimate.

2. The method of claim 1, wherein the one or more parameters comprise one or more of:
data indicating a type of merchant associated with the potentially fraudulent transaction;
an amount associated with the potentially fraudulent transaction;
a time of day associated with the potentially fraudulent transaction; and
a day of a week associated with the potentially fraudulent transaction.

3. The method of claim 1, wherein determining the fraud score comprises:
inputting the client data to a trained machine learning model; and
outputting the fraud score using the trained machine learning model.

4. The method of claim 1, wherein:
the client data further comprises data relating to one or more characteristics of the client; and
determining the fraud score is further based on the data relating to the one or more characteristics of the client.

5. The method of claim 1, wherein the one or more characteristics comprise one or more of: an age of the client; an earning potential or a salary of the client; a gender of the client; an address of the client; and a credit score of the client.

6. The method of claim 1, wherein determining the fraud score comprises:
extracting, based on the data relating to the historical financial transactions associated with the client, one or more client transaction features;
comparing the one or more client transaction features to stored client transaction features; and
based on the comparison, determining the fraud score.

7. The method of claim 6, wherein the one or more client transaction features and the stored client transaction features are representative of one or more of: types of merchants; for each type of merchant from among multiple types of merchants, amounts associated with the type of merchant; one or more spending patterns; times of day; and days of a week.

8. The method of claim 6, further comprising, prior to receiving the fraud claim from the client, obtaining the stored client transaction features by:
retrieving other client data associated with multiple other clients, wherein the other client data comprises data relating to historical financial transactions associated with the other clients;
extracting, based on the data relating to the historical financial transactions associated with the other clients, other client transaction features; and
storing the other client transaction features.

9. The method of claim 8, wherein retrieving the other client data comprises:
retrieving a dataset of client data;
extracting features from the dataset of client data;
based on one or more similarities between the extracted features, assigning each feature to one of multiple groups; and
retrieving the other client data from one of the groups.

10. The method of claim 8, wherein extracting the other client transaction features comprises:
inputting the other client data to a trained machine learning model; and
outputting the other client transaction features using the trained machine learning model.

11. The method of claim 4, wherein determining the fraud score further comprises:
extracting, based on the data relating to the one or more characteristics of the client, one or more client characteristic features;
comparing the one or more client characteristic features to stored other client characteristic features; and
based on the comparison, determining the fraud score.

12. The method of claim 11, further comprising, prior to receiving the fraud claim from the client, obtaining the stored other client characteristic features by:
retrieving other client data associated with multiple other clients, wherein the other client data comprises data relating to characteristics associated with the other clients;
extracting, based on the data relating to the characteristics associated with the other clients, other client characteristic features; and
storing the other client characteristic features.

13. The method of claim 12, wherein retrieving other client data associated with multiple other clients comprises:
retrieving a dataset of client data;
extracting features from the dataset of client data;
based on one or more similarities between the extracted features, assigning each feature to one of multiple groups; and
retrieving the other client data associated with the multiple other clients.

14. The method of claim 12, wherein extracting the other client characteristic features comprises:
inputting the other client data to a trained machine learning model; and
outputting the other client characteristic features using the trained machine learning model.

15. The method of claim 4, wherein determining the fraud score comprises:
extracting, based on the data relating to the historical financial transactions associated with the client, one or more client transaction features;
comparing the one or more client transaction features to stored client transaction features;
extracting, based on the data relating to the one or more characteristics of the client, one or more client characteristic features;
comparing the one or more client characteristic features to stored other client characteristic features; and
based on the comparisons, determining the fraud score.

16. The method of claim 1, wherein determining whether the fraud claim is legitimate comprises:
comparing the fraud score to a threshold; and
based on the comparison, determining whether the fraud claim is legitimate.

17. The method of claim 1, wherein:
determining whether the fraud claim is legitimate comprises determining that the fraud claim is legitimate; and
the method further comprises, in response to determining that the fraud claim is legitimate, initiating an instruction so as to reverse the potentially fraudulent transaction.

18. The method of claim 1, further comprising, prior to determining whether the fraud claim is legitimate:
determining a trust score associated with the client; and
adjusting the fraud score based on the trust score,
wherein determining whether the fraud claim is legitimate is further based on the adjusted fraud score.

19. A system for determining whether a fraud claim initiated by a client is legitimate, the system comprising:
one or more databases storing client data, wherein the client data comprises data relating to historical financial transactions associated with the client; and
one or more processors configured to:
receive the fraud claim from the client, wherein the fraud claim is in respect of a potentially fraudulent transaction associated with the client;
retrieve the client data from the one or more databases;
determine, based on the data relating to the historical financial transactions associated with the client, and based on one or more parameters of the potentially fraudulent transaction, a fraud score associated with the fraud claim; and
determine, based on the fraud score, whether the fraud claim is legitimate.

20. A computer-readable medium having stored thereon computer program code configured when executed by one or more processors to cause the one or more processors to perform a method comprising:
receiving the fraud claim from the client, wherein the fraud claim is in respect of a potentially fraudulent transaction associated with the client;
retrieving client data associated with the client, wherein the client data comprises data relating to historical financial transactions associated with the client;
determining, based on the data relating to the historical financial transactions associated with the client, and based on one or more parameters of the potentially fraudulent transaction, a fraud score associated with the fraud claim; and
determining, based on the fraud score, whether the fraud claim is legitimate.
